(19) United States
(12) Patent Application Publication
(10) Pub. No.: US 2022/0338508 A1
(43) Pub. Date: Oct. 27, 2022

(54) NATURAL NON-ALCOHOLIC BEVERAGE PRODUCTS WITH ENHANCED NATURAL FLAVOUR AND TASTE PROFILES

(71) Applicant: CLIFF DUNDEE PTY LTD, Armadale (AU)

(72) Inventors: William WADE, Victoria (AU); Aaron TROTMAN, Victoria (AU)

(21) Appl. No.: 17/764,196

(22) PCT Filed: Aug. 27, 2020
(86) PCT No.: PCT/IB2020/057995

§ 371 Date: Mar. 27, 2022

(30) Foreign Application Priority Data
Aug. 27, 2019 (AU) 2019903127

(51) Int. Cl. A23L 2/04; A23L 2/60; A23L 2/56

(52) U.S. Cl. CPC A23L 2/04; A23L 2/60; A23L 2/56; A23V 2002/00

(57) ABSTRACT

A natural non-alcoholic beverage product, comprising two or more natural fruit flavours extracted and concentrated from two or more fruits, one or more natural botanical flavours extracted and concentrated from parts of one or more plants and at least one of a natural spice flavour, a natural unrefined sweetener, and a natural unrefined salt.

### FIELD

The present invention relates to natural non-alcoholic beverages with enhanced natural flavour and taste profiles.

### BACKGROUND

There is growing market demand for non-alcoholic alternatives to wine that can be paired or matched with food in restaurants. In addition, there is increasing consumer interest in beverages whose formulations make greater use of natural ingredients, such as ingredients distilled, extracted, concentrated or similarly obtained from harvested plants and other naturally occurring sources, with limited or no further processing. Also, there is greater market demand for beverages having alternative flavour profiles, including good taste, mouthfeel, etc.

Conventional non-alcoholic beverages, such as carbonated fruit or cola drinks, have unsophisticated flavours and mouthfeels that are ill-suited to food/drink matching, especially for pairing with complex dishes of modern fine-dining, high-end cuisine.

In view of this background, there is an unmet need for “restaurant-quality” natural non-alcoholic beverage products with enhanced natural flavour and taste profiles that are suitable for food/drink matching.

### SUMMARY

According to the present invention, there is provided a natural non-alcoholic beverage product, comprising:

two or more natural fruit flavours extracted and concentrated from two or more fruits;

one or more natural botanical flavours extracted and concentrated from parts of one or more plants; and

at least one of a natural spice flavour, a natural unrefined sweetener, and a natural unrefined salt.

The natural non-alcoholic beverage product may be carbonated or non-carbonated.

The two or more fruits may be selected from plum, prune, grape, raisin, blueberry, raspberry, blackberry, strawberry, Kakadu plum, lemon aspen, Davidson's plum, quandong, riberry, orange, cocoa, cherry, cranberry, bilberry, kiwifruit, acai berry, grapefruit, pear, apricot, banana, apple, blackcurrant, avocado, boysenberry, cantaloupe, coconut, dragonfruit, durian, date, elderberry, goji berry, guava, huckleberry, jackfruit, juniper berry, kumquat, lemon, yuzu, lime, Australian desert lime, bush tomato, mango, honeydew melon, watermelon, mulberry, nectarine, olive, mandarin, papaya, peach, persimmon, pomegranate, pineapple, pomelo, quince, mango, red current, rambutan, starfruit, tamarillo, ugil fruit, coffee, soya bean, miso, jalapeno, ancho chilli, chipotle, cocoa, and corn binations thereof.

The parts of one or more plants may be selected from grasses, leaves, flowers, seeds, bark, bulbs, stalks, stems, aril and roots, including seaweed, kaffir lime leaf, oak, hickory, charcoal, agave, salt bush, rhubarb, turnip, celery, hops, grains, basil, dill, bay leaf, chive, cress, alfalfa, marshmallow, lavender, lemon grass, Tasmania pepper, lemon myrtle, anise myrtle, marjoram, mint, mugwort, lemon balm, epazote, curry leaf, parsley, shiso, sansho leaf, sansho pepper, Sichuan pepper, kelp, kombu, lovage, hyssop, valerian, yarrow, sorrel, tarragon, chervil, jimbu, woodruff, hemp, rue, mitsuba, rosemary, sage, oregano, thyme, spearmint, peppermint, coriander, cinnamon, cassia, fennel, fenugreek, dill mustard, clove, saffron, onion, garlic, leek, ginger, turmeric, grape seed, black pepper, star anise, soy, mace, green tea, white tea, yellow tea, herbal tea, oolong tea, black tea, chai tea, chamomile tea, earl grey tea, Gui Fei tea, horchacha tea, anise myrtle, pumpkin seed, rice, hibiscus, native hibiscus (rosella), lemon verbena, lemon myrtle, and combinations thereof.

The natural spice flavour may be selected from grasses, flowers, seeds, bark, bulbs, stalks, stems, aril and roots, including wattleseed, saffron, ginger, turmeric, grape seed, chilli pepper, cumin, allspice, anise, carraway, cardamom, cassia, cinnamon, clove, coriander, cumin, fennel, fenugreek, galangal, garlic, ginger, horseradish, kokum, mustard, nutmeg, poppy seed, rose, paprika, saffron, sumac, tamarind, turmeric, vanilla, sesame, sarsaparilla, sassafras, tonka bean, and combinations thereof.

The natural unrefined sweetener may be selected from honey, cane sugar, unrefined caster sugar, and combinations thereof.

The two or more natural fruit flavours, and the one or more natural botanical flavours, may be extracted and concentrated by one or more of heating, distilling, brewing, boiling, stirring, filtering, pressing, macerating, grounding, drying, dehydrating, roasting, toasting, caramelising, and combinations thereof.

The natural non-alcoholic beverage product may comprise a balance of an acidic component, a sugar component, and a salt component. The acidic component may, for example, be selected from a group comprising verjuice, yuzu juice, and alpha acid from hops. The sugar component may, for example, be selected from a group comprising organic cane sugar, pear juice, and vegetables such as beetroot. The salt component may, for example, be selected from a group comprising Murray River salt, olive brine, preserved lemon brine, and feta brine.

The present invention also provides a method of making a natural non-alcoholic beverage product, the method comprising:

extracting and concentrating two or more natural fruit flavours from two or more fruits;

extracting and concentrating one or more natural botanical flavours from parts of one or more plants;

selecting at least one of a natural spice flavour, a natural unrefined sweetener, and a natural unrefined salt;

combining the extracted, concentrated and selected natural ingredients with water to form the natural non-alcoholic beverage product.

The method may further comprise carbonating the natural non-alcoholic beverage product.

### BRIEF DESCRIPTION OF DRAWINGS

Embodiments of the invention will now be described by way of example only with reference to the accompanying drawings, in which:

FIG. 1 is a flowchart of a method of making a natural non-alcoholic beverage product according to an embodiment of the present invention.

### DESCRIPTION OF EMBODIMENTS

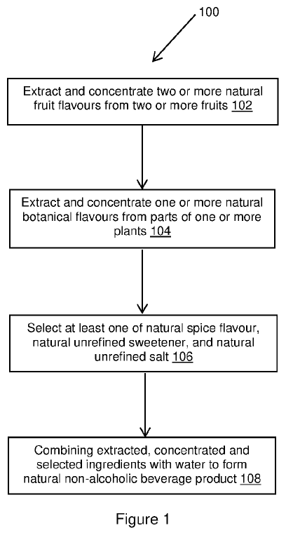

FIG. 1 illustrates a method 100 of making a natural non-alcoholic beverage product according to an embodiment of the present invention. As used herein the term “natural flavour” is understood to mean that the flavour is obtained from a natural source, such as plant material, with minimal or no processing, and without appreciably altering the natural flavour of the natural source.

The method 100 may start at step 102 by extracting and concentrating two or more natural fruit flavours from two or more fruits. The two or more fruits may be selected from plum, prune, grape, raisin, blueberry, raspberry, blackberry, strawberry, Kakadu plum, lemon aspen, Davidson's plum, quandong, riberry, orange, cocoa, cherry, cranberry, bilberry, kiwifruit, acai berry, grapefruit, pear, apricot, banana, apple, blackcurrant, avocado, boysenberry, cantaloupe, coconut, dragonfruit, durian, date, elderberry, goji berry, guava, huckleberry, jackfruit, juniper berry, kumquat, lemon, yuzu, lime, Australian desert lime, bush tomato, mango, honeydew melon, watermelon, mulberry, nectarine, olive, mandarin, papaya, peach, persimmon, pomegranate, pineapple, pomelo, quince, mango, red current, rambutan, starfruit, tamarillo, ugil fruit, coffee, soya bean, miso, jalapeño, ancho chilli, chipotle, and combinations thereof. As used herein, “natural fruit flavours” includes natural juices or extracts of fruits, such as verjuice from grapes, olive brine from olives, chilli powder from chillis, etc.

Next at step 104, one or more natural botanical flavours may be extracted and concentrated from parts of one or more plants other than their fruits. The parts of one or more plants may be selected from grasses, leaves, flowers, seeds, bark, bulbs, stalks, stems, aril and roots, including seaweed, kaffir lime leaf, oak, hickory, charcoal, agave, salt bush, rhubarb, turnip, celery, hops, grains, basil, dill, bay leaf, chive, cress, alfalfa, marshmallow, lavender, lemon grass, Tasmania pepper, lemon myrtle, anise myrtle, marjoram, mint, mugwort, lemon balm, epazote, curry leaf, parsley, shiso, sansho leaf, sansho pepper, Sichuan pepper, kelp, kombu, lovage, hyssop, valerian, yarrow, sorrel, tarragon, chervil, jimbu, woodruff, hemp, rue, mitsuba, rosemary, sage, oregano, thyme, spearmint, peppermint, coriander, cinnamon, cassia, fennel, fenugreek, dill mustard, clove, saffron, onion, garlic, leek, ginger, turmeric, grape seed, black pepper, star anise, soy, mace, green tea, white tea, yellow tea, herbal tea, oolong tea, black tea, chai tea, chamomile tea, earl grey tea, Gui Fei tea, horchacha tea, anise myrtle, pumpkin seed, rice, hibiscus, native hibiscus (rosella), lemon verbena, lemon myrtle, and combinations thereof.

The extraction and concentration of the two or more natural fruit flavours at step 102, and the one or more natural botanical flavours at step 104, may be performed by one or more of heating, distilling, brewing, boiling, stirring, filtering, pressing, macerating, grounding, drying, dehydrating, roasting, toasting, caramelising, and combinations thereof.

The method 100 may then move to step 106 by selecting at least one of a natural spice flavour, a natural unrefined sweetener, and a natural unrefined salt. The natural spice flavour may be selected from any part of a plant that is not a leaf, including, grasses, flowers, seeds, bark, bulbs, stalks, stems, aril and roots, including wattleseed, saffron, ginger, turmeric, grape seed, chilli pepper, cumin, allspice, anise, carraway, cardamom, cassia, cinnamon, clove, coriander, cumin, fennel, fenugreek, galangal, garlic, ginger, horseradish, kokum, mustard, nutmeg, poppy seed, rose, paprika, saffron, sumac, tamarind, turmeric, vanilla, sesame, sarsaparilla, sassafras, tonka bean, and combinations thereof. The natural unrefined sweetener may be selected from honey, cane sugar, unrefined caster sugar, and combinations thereof.

Optionally, one or more further natural flavours may be used, for example, one or more natural dairy flavours, and/or one or more natural vegetable flavours. The one more or more natural flavours may, for example, comprise lees or sediment of wine in barrels. The one or more natural dairy flavours may, for example, be selected from sheep's whey, goat's whey, cow's whey, and combinations thereof.

The natural flavours and tastes of the beverage products or compositions obtained by the above steps may be “balanced” using chef's cooking techniques. The term “balanced” may refer to the natural flavour components being combined in relative proportions in the beverage product so that the resulting composition provides a composite natural flavour and taste profile without the flavour of any one of the flavour components being noticeable or dominant. For example, the beverage product may comprise a balance of an acidic component, a sugar component, and a salt component. The acidic component may, for example, be selected from a group comprising verjuice, yuzu juice, and alpha acid from hops. The sugar component may, for example, be selected from a group comprising organic cane sugar, pear juice, and vegetables such as beetroot. The salt component may, for example, be selected from a group comprising Murray River salt, olive brine, preserved lemon brine, and feta brine.

In some embodiments, the beverage product may comprise a tisane (an infusion of dried fruits, herbs and spices in hot water). In some embodiments, the fruit may be roasted, dehydrated, and cooked sous vide. It may then be steeped in hot water with herbs and spices, filtered and optionally carbonated overnight.

The method 100 may end at step 108 where the extracted, concentrated and selected natural ingredients are combined with water to form a natural non-alcoholic beverage product.

Optionally, the method 100 may further comprise carbonating the natural non-alcoholic beverage product.

The invention will now be described in more detail, by way of illustration only, with reference to the following examples. The examples are intended to serve to illustrate embodiments of the invention, and should not be construed as limiting the generality of the disclosure of the description throughout this specification.

### EXAMPLES

### Example 1—Salted Raspberry and Chamomile

A batch comprising concentrated raspberry extract, chamomile tea extract, verjuice, natural unrefined salt, unrefined caster sugar, and water was prepared. The batch was heated to 90 degrees. The resulting natural non-alcoholic beverage product was bottled and carbonated to a level similar to sparkling wine.

### Example 2—Caramelised Pear and Kombu

A batch comprising concentrated pear extract, kombu extract, vanilla, verjuice, chai tea extract, olive brine, and water was prepared. The batch was heated to 85 degrees. The resulting natural non-alcoholic beverage product was bottled and carbonated to a level similar to cider.

### Example 3—Toasted Cinnamon and Yuzu

A batch comprising concentrated orange extract, concentrated yuzu extract, cinnamon, verjuice, natural unrefined salt, unrefined cane sugar, and water was prepared. The batch was heated to 85 degrees. The resulting natural non-alcoholic beverage product was bottled and left uncarbonated.

Samples of Examples 1 to 3 were tasted and found to possess unique mouthfeels and natural flavour profiles with different unique natural combinations of sweet, sour, salty, bitter, and umami flavours.

Without intending to be bound to any particular theory, it is believed that the specially selected natural flavours obtained by embodiments of the invention synergistically combine, physico-chemically interact, and harmonise with one another to give the resulting natural non-alcoholic beverage products enhanced natural flavour and taste profiles. The combinations of natural flavours possess synergy or emergence that delivers new natural flavour experiences which are suitable for food/drink matching.

Embodiments of the present invention provide “restaurant-quality” natural non-alcoholic beverage products with enhanced natural flavour and taste profiles that are both generally and specifically useful for food/drink matching, and as refined, complex alternatives to wine or alcohol.

For the purpose of this specification, the word “comprising” means “including but not limited to,” and the word “comprises” has a corresponding meaning.

The above embodiments have been described by way of example only and modifications are possible within the scope of the claims that follow.

1-13. (canceled)

14. A non-alcoholic beverage, comprising:
an extracted liquid containing natural fruit flavours and natural tea flavours obtained by heating fruit together with tea leaves in water;
wherein the extracted liquid further contains verjuice.

15. The non-alcoholic beverage of claim 14, wherein the extracted liquid further contains a natural unrefined salt.

16. The non-alcoholic beverage of claim 15, wherein the extracted liquid further contains a natural unrefined sweetener.

17. The non-alcoholic beverage of claim 16, further comprising a natural spice flavor.

18. A method of preparing a non-alcoholic beverage, comprising:
heating fruit together with tea leaves in water to obtain an extracted liquid containing natural fruit flavours and natural tea flavours;
adding verjuice to the extracted liquid.

19. The method of claim 18, further comprising adding a natural unrefined salt to the extracted liquid.

20. The method of claim 19, further comprising adding a natural unrefined sweetener to the extracted liquid.

21. The method of claim 20, further comprising adding a natural spice flavor to the extracted liquid.
